(19) United States
(12) Patent Application Publication
(10) Pub. No.: US 2006/0155764 A1
(43) Pub. Date: Jul. 13, 2006

(54) Personal online information management system

(76) Inventor: Peng Tao, Santa Clara, CA (US)

Correspondence Address: FORTUNE LAW GROUP LLP, 100 CENTURY CENTER COURT, SUITE 315, SAN JOSE, CA, 95112, US

(21) Appl. No.: 11/214,542

(22) Filed: Aug. 29, 2005

Related U.S. Application Data
(60) Provisional application No. 60/607,789, filed on Aug. 27, 2004.

(51) Int. Cl. G06F 7/00

(52) U.S. Cl. 707/104.1

(57) ABSTRACT

A personal online information management system allows users to monitor, manage, retrieve, and utilize their personal online behaviors such as browsing, searching, editing/commenting, discussion, shopping, and peer to peer communications. The system provides personalized service with explicitly self-controlled privacy protection. The system enables an anonymous or identified user to easily switch between a monitored mode and an un-monitored mode.

### CROSS REFERENCE TO RELATED APPLICATIONS

The present application claims priority under 35 U.S.C. 119(e) from provisional patent application Ser. No. 60/607,789, entitled “Personal Online Information Management System”, filed on Aug. 27, 2004, the disclosure of which is herein incorporated by reference in its entirety.

### BACKGROUND OF THE INVENTION

The present invention relates generally to information management systems and more particularly to a personal online information management system including a user-controlled online behavior collection approach.

Today, people are spending more and more time online. They are accessing more and more information and engaging in more and more activities online. This explosion of online activity has spurred development in the prior art of systems and methods for enabling users to retrieve their online activities. However these systems and method suffer many disadvantages.

By way of illustration, a user may wish to find a technical article the user read online previously about the internet and animation, for the purpose of researching and developing relevant technologies. If the user hasn't saved the article locally, the user may go to a search engine's web site, such as www.google.com, and type in the query “internet, animation”. The web resource sought by the user may not be listed in the web resources returned by the search engine in the first few pages or may even be non-existent. FIG. 1 shows an example of web resources returned using the Google search engine, where the desired search result 101 is shown on the 4^{th} page of the returned web resources.

Alternatively the user may use the history button in the Internet Explorer browser to search the history of the user's online activity. The disadvantages of such a history search include the possibility that links to pages visited many days ago may not be kept in the history folder, as the history folder may only keep records of those web resources browsed within a certain number of days such as the most recent 30 days. FIG. 2 shows that no visited page was found for the query “internet, animation”.

Additionally, the speed with which the history search is performed may be very slow compared to the speed of a search performed by a engine search. In many cases the history search may take more than 5 seconds and sometimes more than 20 seconds to display the result. Furthermore, the results shown in a history search pane are not well presented and are generally not ranked appropriately. FIG. 3 shows the history search result for the stock ticker ‘OVTI’ where only brief titles for the links are displayed and there are many totally irrelevant pages displayed.

If the user has saved a copy of the web resource locally, it may be difficult for the user to find the article given that in many cases the user can't remember in which folder the article was put. The user may input a key word to search the files in the local PC, but the process is generally slow and it may take many minutes for the user to get any results. Furthermore, the user interface is generally not very user friendly and may comprise only file names. Even if the user correctly remembers the copy's local location, it may still take the user many seconds to go to the folder and open the local file. FIG. 4 shows an example of using a desktop ‘search files or folders’ function to find the saved copy. As shown, the search results are not well organized in a user friendly manner.

This problem is such that the Microsoft Corporation has noticed it and is researching ways to improve the ‘search’ functionality of computing machines. Microsoft plans one such implementation associated its new file system WinFS in its new Longhorn product.

Even if Microsoft can achieve an economic and efficient local searching engine it will remain suspicious as it involves the great cost of updating and managing index tables for the words inside the content files. Searching ideally should be done on the server side as the local search solution presents several generic defects. One such defect relates to the interruption of the user's normal work on the local machine for the purpose of saving online files. The user may have to go through several steps to achieve the saving task including filling out a pop-up form, going though a browsing process to find the folder to store the file in, and executing the download process. All these actions interrupt the user's normal online experience.

Additionally, local saving solutions usually only allow the user to save the entire online page. The saving solutions never recognize and allow the user to save the user's online actions related to objects inside the page. Further, these solutions do not allows the user to select a section inside the page to save. For example, when the user wishes to store only one interesting eCommerce offering out of many offerings in a given page or save only given paragraphs in the page, the user has to open a local file and copy and paste the selected parts which is very inconvenient for the user.

Local saving solutions suffer the disadvantage that it may be difficult to retrieve the information stored in the local machine when the user cannot physically access the local machine. For example, it is not convenient for the user to access the user's PC, when the user is using a different PC. Finally, it may be difficult for the user to selectively share the information stored, collaborate with peers, and make and get recommendations to and from peers based on the information stored.

Additional prior art systems and methods for collecting and storing a user's online behaviors include client-side or peer-to-peer software such as Gator, EZula, WhenU, and Kazza. These products may be used to collect the user's behavior and provide the user certain benefits such as filling in online forms automatically. However these products usually include many popup ads which usually bother the user. These products further do not have the functionality enabling the user to selectively collect the information per the user's real time requests. Users have no control over which files and behaviors are collected by the products and users cannot use or retrieve the collected information. Worst of all, after the user has installed the software, all the user's online behavior will be tracked and stored in a data base. This poses a serious threat to the user's privacy.

Yodlee is another service provider that aggregates the user's online financial activities information and enables the user to retrieve their activity. However, this solution is limited to the user's financial activities such as banking and billing and is not effective in collecting and managing the user's other online activities such as browsing, searching and shopping.

Many online businesses use cookies to collect the user's online behavior. For example, Yahoo analyzes the cookies of the user browsing the Yahoo site and uses this information to target the user and display advertisements with higher target precision. DoubleClick deploys cookies in enormous websites and makes an effort to integrate the information stored in the cookies to deliver ads.

The cookie solution also raises privacy concerns although the P3P is attempting to solve the problem partially. The other limitation of the cookie solution is that cookies cannot be used across web sites by nature, as cookie information in a web site cannot be used by the other websites. Finally, a major problem with the cookie solution is that the information stored in the cookies cannot help users manage and retrieve their online activities.

Some eCommerce websites collect the user's on-line commercial transactions in the website and use this information to recommend to the user certain offerings. Such websites may also allow the user to track their transaction records in such websites. For example, Amazon provides a personalized recommendation system for its users. Amazon generally provides a personalized solution to the user. Users can easily retrieve their past behavior while browsing Amazon's website and generally get good recommendations from Amazon based upon their past behaviors. However, this solution is limited to the specific site and it is impossible for users to manage and retrieve their behavior across websites.

There is therefore a need in the art for a personal online information management system that overcomes the disadvantages of the prior art. There is also a need for a system and method that provides a user-controlled means for enabling a user to easily select web resources or objects within web resources and associated user actions related to the objects. There is a further need for a system and method that allows the user to store the web resources and objects, and associated actions, in an information management system that enables easy management and retrieval. There is also a need for a system and method that allows the user to search for and retrieve the stored resources and actions using key words. There is also a need for a system and method that tracks changes in selected web resources and notifies the user of such changes. There is a further need for a system and method that is operable to notify the user of web resources based upon an analysis of the user's online behavior. There is also a need for a system and method having integrated user functionality such as dictionaries and translation tools. There is a further need for a system and method that is operable to allow the sharing of web resources.

### SUMMARY OF THE INVENTION

The present invention provides a personal online information management system that enables a user to selectively capture content and web resources and to save and record the selected content and web resources for future retrieval. The system further enables the user to save and record the user's actions associated with such content and web resources. The system also enables the user to easily and precisely control the monitoring and recording of the content and the user's actions associated with the content and make them useful in the future. The system also provides users with absolute control over which activities and online resources are recorded to ensure the privacy of the user. The system further provides users with control over access to the selected content to ensure the privacy of the user.

The system of the invention is operable to enable the user to manage the collected personal online behavior information and associated content and to enable the user to edit the collected personal online behavior information. In this manner, the user can view and edit all the selected online activities and web resources across a plurality of websites. The user can also easily and quickly find past activities and visited web resources via various searching approaches such as keyword searches and easily keep track of and get notification about changes related to the selected web pages and commercial offerings. The system further enables collaboration between peers to make and get recommendations based on selected historical records. Furthermore, the system provides the user with an optional anonymous communication mechanism which enables the user to be completely anonymous in relation to the service provider managing the personal online information management system while getting spam free service and technical support from the service provider.

In one aspect of the invention, a personal information management system comprises an information collection module having a client side switch module coupled to a server side behavior collector module, the information collection module being operable to enable a user to selectively save, manage and retrieve content accessed in a network environment.

In another aspect of the invention, a personal information management system comprises an information collection module having a client side switch module coupled to a server side behavior collector module, a server side information analysis and management module coupled to the server side behavior collector module, and a server side application module coupled to the server side behavior collector module.

In another aspect of the invention, a personal information management system comprises an information collection module having a client side switch module coupled to a server side behavior collector module, the client side switch being operable to allow the user to switch between a monitored mode and an un-monitored mode, a server side information analysis and management module coupled to the information collection module, the server side information analysis and management module comprising a content analysis server, a category repository and an index table, a server side application module coupled to the server side behavior collector module, the server side application module comprising a search module, a server side user behavior analysis module coupled to the server side behavior collector module, and a server side collaboration module coupled to the server side behavior collector module.

### BRIEF DESCRIPTION OF THE DRAWINGS

FIG. 1 is a screen shot showing the results of a search using a prior art search engine;

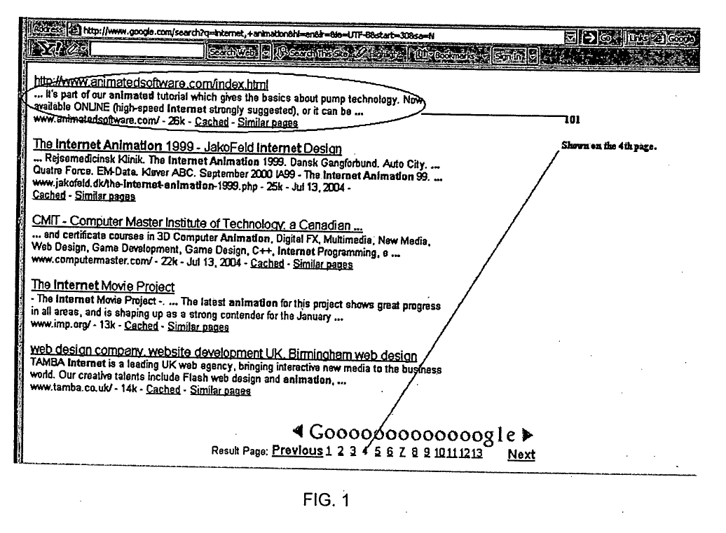

FIG. 2 is a screen shot showing the results of a search using a prior art Internet Explorer history function;

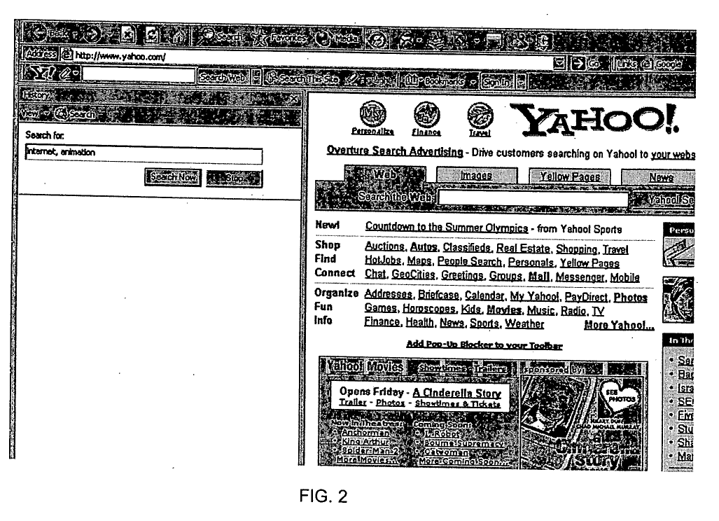

FIG. 3 is a screen shot showing another set of results of a search using the prior art Internet Explorer history function;

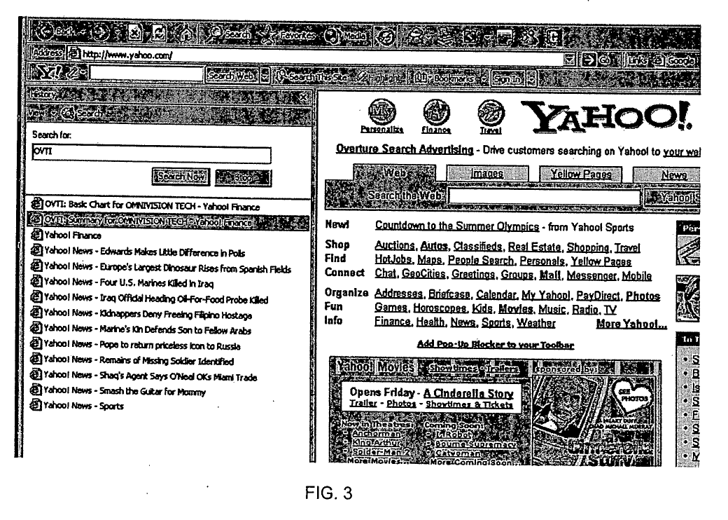

FIG. 4 is a screen shot showing the results of a search using a prior art Microsoft PC search function;

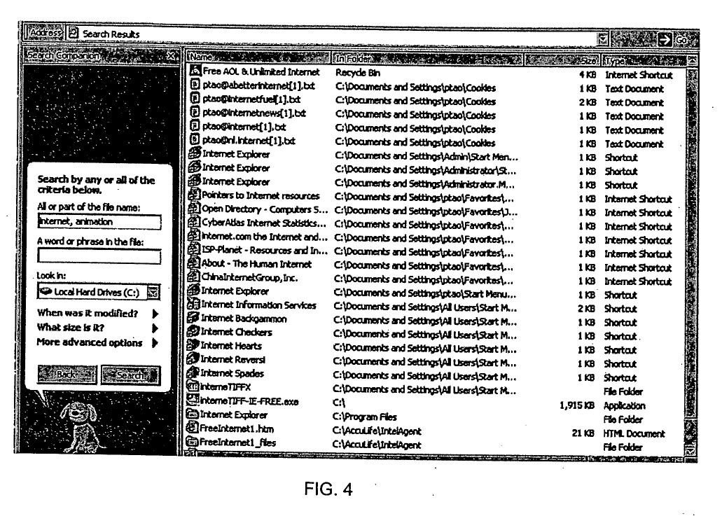

FIG. 5 is a schematic representation of an architecture of the personal online information management system in accordance with the invention;

FIG. 6 is a schematic representation of a client side switch module in accordance with the invention;

FIG. 7 is a screen shot of a user interface in accordance with the invention;

FIG. 8 is a tabular representation showing the monitoring of a user's online behavior in accordance with the invention;

FIG. 9 is a schematic representation of a server side analysis/management module in accordance with the invention;

FIG. 10 is a representation showing an example of categorizing and analyzing the contents of a web resource visited by a user in accordance with the invention;

FIG. 11 is a tabular representation showing an example of creating and updating the user's personal interest profile in accordance with the invention;

FIG. 12 is a tabular representation showing illustrates an example of online collaboration in accordance with the invention;

FIG. 13 is a tabular representation showing an example of using query expanding to do a personalized search in accordance with the invention;

FIG. 14 is a screen shot showing a recommendation page for a registered Amazon user;

FIG. 15 is a representation showing an integration module in accordance with the invention; and

FIG. 16 is a schematic representation showing the layout of application functional modules on the server side in accordance with the invention.

### DETAILED DESCRIPTION OF THE INVENTION

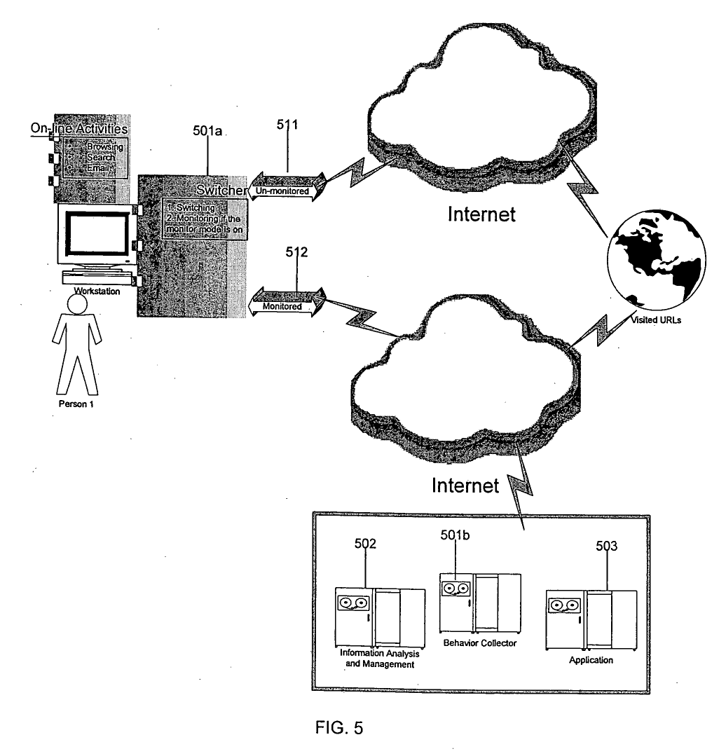

FIG. 5 illustrates a preferred embodiment of the personal online information management system that enables users to save, manage, retrieve, control, and utilize their online behaviors during their online activities, such as browsing, searching, shopping, banking, and chatting. The system may comprise an Information Collection Module, comprising a client side switch module 501a, and a server side behavior collector 501b. The Information Collection Module may enable the user to selectively collect interesting online content and record the user's online behaviors in real time in an interactive network environment.

An Information Analysis and Management Module 502 may manage the collected personal online behavior information and associated contents, and enable the user to retrieve and edit the collected personal online behavior information. An Application Module 503 may utilize the managed information to benefit the user's online activities.

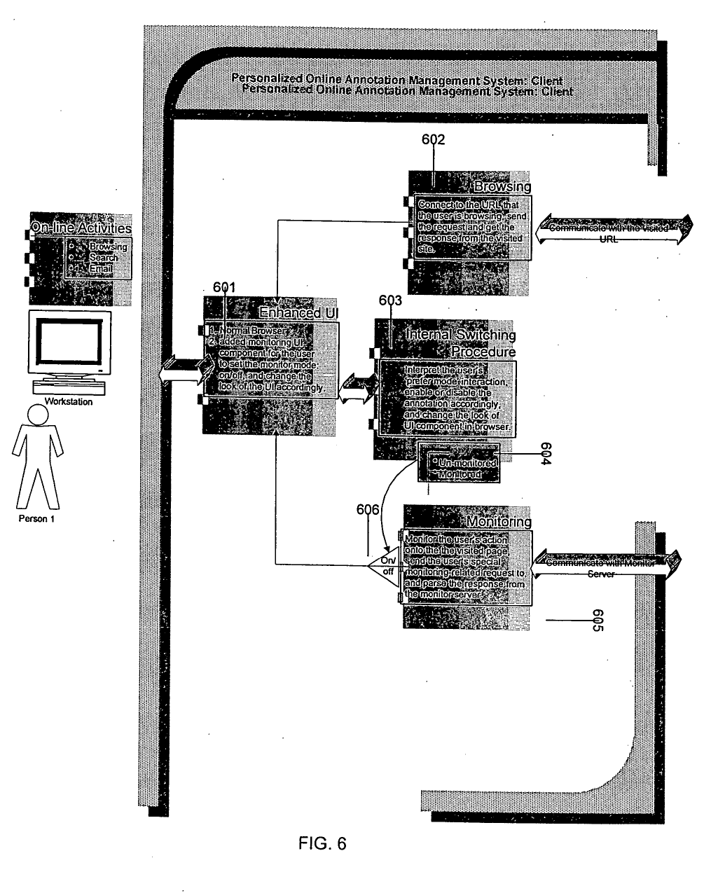

The Information Collection Module is the fundamental part of the system of the invention. FIG. 6 illustrates a preferred embodiment of the switch module 501a including two components. A first component includes a user interface (UI) component 601 which may be added to form an enhanced UI. The UI component 601 may interact with the user and change its look to reflect the user's preferred monitoring status 604 which may be un-monitored or monitored. The UI component 601 always resides in the client side, preferably as a plug-in inside the browser. A second component includes an internal procedure 603 operable to process human interaction with the UI component 601, change the internal monitor mode 604 to un-monitored/monitored, enable/disable the behavior collection module via an on/off switch 606, and change the look of the UI on the client side accordingly. Whichever mode is set, the user is always able to browse and the browsing requests are sent and responses will be returned via a normal browsing process 602. Only when the monitoring mode is on will the user's activities be monitored and requests sent to and responses returned from server side modules via process 605.

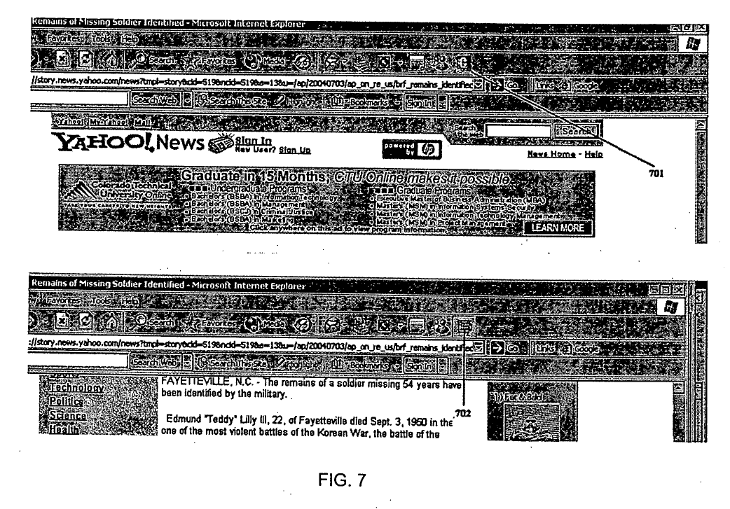

FIG. 7 illustrates an example of UI component 601 which may be implemented as a button 701 of a toolbar or explorer bar in the browser. When the button 701 is selected and set to ‘off’ mode, the look of the button will be displayed as 701 in FIG. 7 and the user will experience normal online browsing without being monitored. When the button 701 is pressed again and set to ‘on’ mode, it looks different to make the user aware of the monitoring status as shown at 702 in FIG. 7.

The monitoring status for the user's current activity determines whether contents of objects inside visited web resources and the user's relevant actions relating to the objects are collected by software residing on the client side or sent to server side service provider.

The ‘contents of the visited objects’ can be the header, title, URL, and contents of the browsed page, the returned result of a search, an ecommerce's online product description, the contents of an online shopping cart, and online banking information. The ‘user's relevant actions onto the object’, can be, but is not limited to the following exemplary actions; browsing the content of text objects of a URL, clicking on certain embedded sub-objects such as buttons and links inside objects, selecting part of the sub-objects such as several paragraphs or sentences of text content, clicking on hits from a list of returned search results, adding an item onto an eShopping cart, and an online financial transaction.

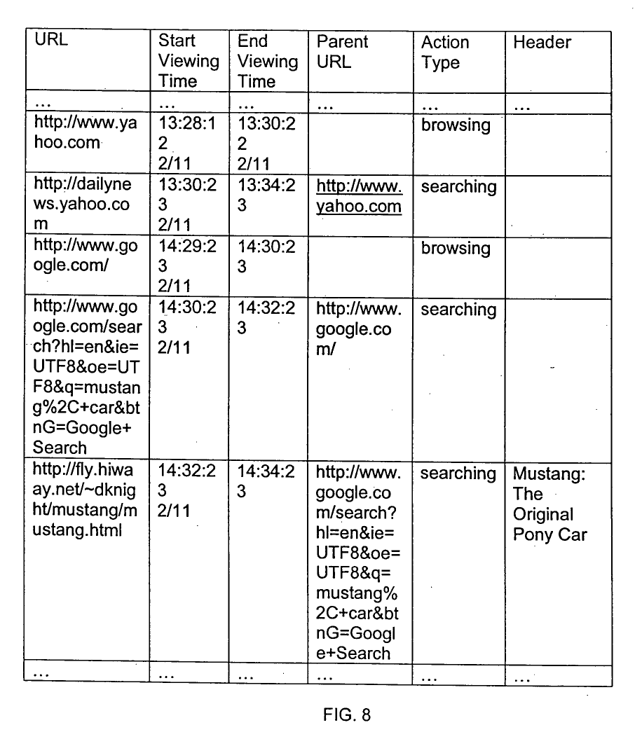

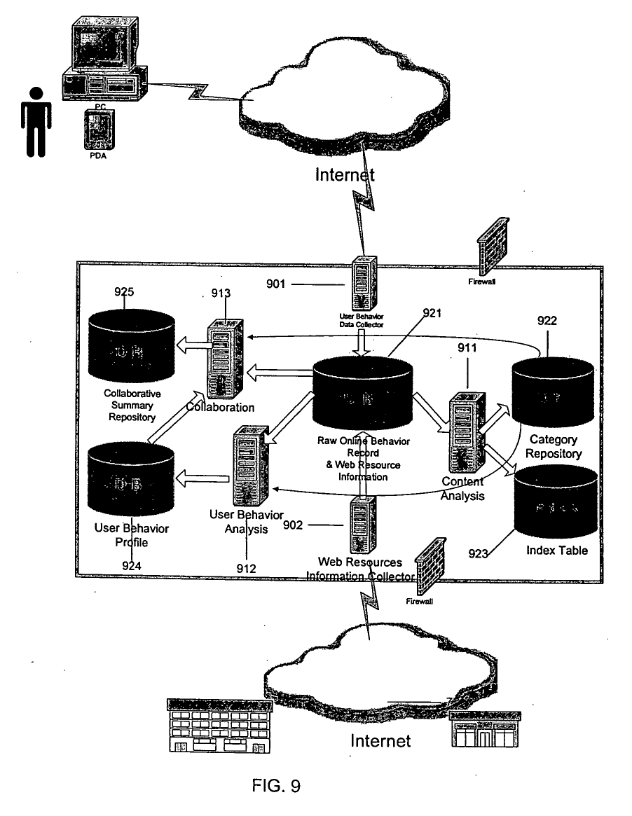

FIG. 8 shows an exemplary record of the user's behavior including the URL of the visited web resource, a start viewing time, an end viewing time, a parent URL, the user's action type and a header. All records collected in the behavior collector module 501b may be analyzed and re-organized in the Information Analysis and Management Module 502. FIG. 9 shows the Information Analysis and Management Module 502 in the server side. All of the components of the Information Analysis and Management Module 502 do their work on top of the repository “Raw online behavior record and web information resources” 921 which may contain all of the user's raw online behavior records collected via a user behavior collector 901 and all the relevant web resources information collected via a web resource information collector 902.

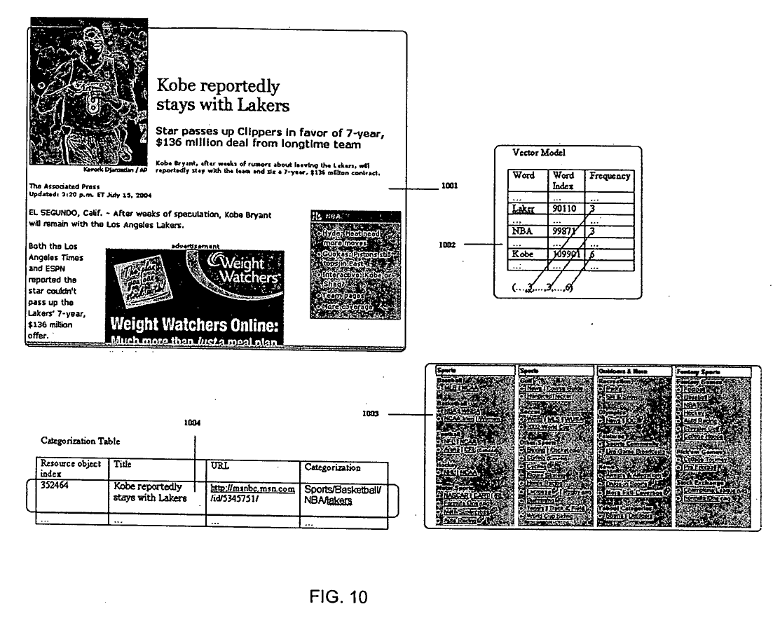

The analysis/management module 502 may include a content analysis server 911, a category repository 922, and an index table 923. The content analysis server 911 may be used to convert the non-structured web text contents into the structured data. The content analysis server 911 may parse, categorize and analyze the non-structured web resource information data collected by web resource information collector 902 and stored in the repository “Raw online behavior record and web information resources” 921. The content analysis server 911 may further be operable to categorize the visited online objects (e.g., web pages) and place the categorization information in a category repository 922 and index the visited objects into an index table 923. An exemplary content analysis process is illustrated in FIG. 10.

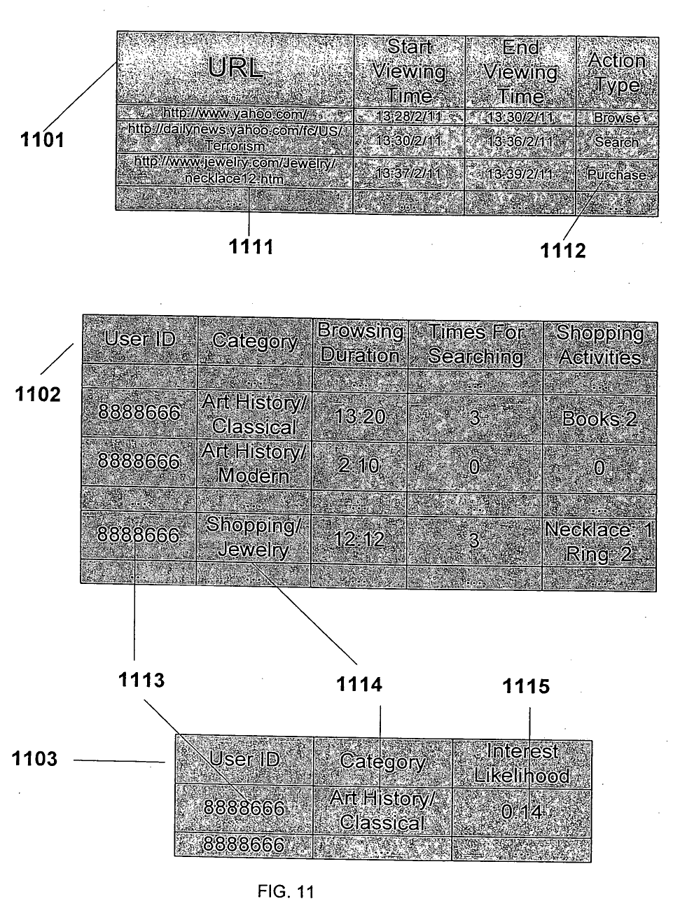

A User Behavior Analysis Module may include a user behavior analysis server 912 and user behavior repository 924. The User Behavior Analysis Module may be operable to create and update the user's personal interest profile from the user's recent online behavior. Generally, user behavior analysis server 912 may use the user behavior information and the visited web resource information, which reside in repository 921, and the category information associated with the visited web resources, which resides in the category repository 922, to calculate the user's interest likelihood scores for various categories, and store the likelihood scores to user behavior repository 924. An exemplary user behavior analysis process is illustrated in FIG. 11.

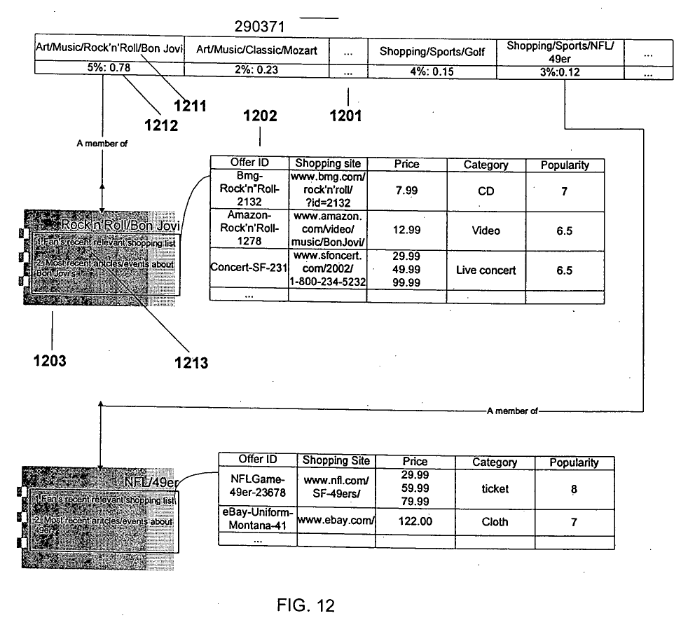

A Collaboration module consists of a collaboration server 913 and a collaborative summary repository 925. The Collaboration module may be used to summarize and do statistical analysis of the date in the user's online behavior record by category and make recommendations to users by topic. Generally, the collaboration server 913 will summarize the users behavior data on the visited web resources (stored in raw data repository 921), and category information associated with the web resource (stored in category repository 922), and give a summary of each category and put the summary into the collaborative summary repository 925. For each category, the collaboration server 913 will further collect the users who shows interest in the category, and summarize these users' raw online behavior records which also fall into the category, and place the summaries per user per category. Finally, the collaboration server 913 may compare the differences between the general summary per category, and particular summary of one user per category, and summarize the differences. The summary of differences per category for each user may be used to make recommendations to the user. FIG. 12 shows an exemplary application of the collaboration module.

A database management module forms a fundamental part of the personal online information management system and may be utilized by the other modules of the invention. The database management module may be responsible for creating, maintaining, and updating the records output by the servers in the other modules. It is implemented via a relational data base. FIG. 11 also illustrates several exemplary tables that are stored in user behavior repository 924.

FIG. 10 illustrates an example of categorizing and analyzing the contents of web resources visited by a user. Web page 1001 is an example a web resource including non-structured or semi-structured contextual contents such as the paragraph entitled “Kobe reportedly stays with Lakers”. First, the main contextual contents of the web page 1001 may be parsed and extracted, and vector space model instances may be built for the main contextual web contents extracted from the URLs. As observed in FIG. 10, the vector model 1002 is built for the exemplary web article 1001: “Kobe reportedly stays with Lakers”. Then, many non-structured data mining algorithms, preferably un-supervised or semi-supervised learning algorithms such as KNN, EM, HEM, TFIDF, LSI (SVD), can be applied to these vector model instances, and form a (hierarchical) clustering or topic/categorization space over the universe of web textual objects. The graph 1003 shows an example of a hierarchical category structure under the category ‘sports’. After the whole categorical hierarchy is formed, all the web resources may be categorized, and presented as records 1004 in a category table. The hierarchical structure may be a graph structure, not a tree structure which means that one topic may be a finer categorization such as a child or sub-categorization under several coarse (parent) categorizations. Simultaneously, an index table may be formed to index all the collected contextual web objects for the purpose of searching.

Based on the user's raw online behavior record and the associated categorization for the visited web resources, the user's interest likelihood profiles can be calculated. FIG. 11 illustrates an example of creating and updating the user's personal interest profile. The raw online behavior records 1101 show the selected records of one registered user, including the URL 1111, the time the user spend on the pages, and the type 1112 of actions the user took on particular subjects. Based on the information shown on the user's online behavior record, and their associated category, a statistical summary 1102 about the registered user (1113)'s activity in different categories 1114 may be generated. Finally, the likelihood scores 1115 for all the online activities will be calculated, with more weight being given to the most recent activities. The calculation involves using the correlation between different categories and Bayesian statistics.

In the process of calculating the user's online browsing interest likelihood, other information, such as the time range (morning, afternoon, or evening), duration (how long the user spend on the web pages) may also be considered to sum the likelihood score of the user's interest category with the weight of time duration. Besides, more recent behavior may carry more weight in the summation than older behavior.

Based on knowing the user's online behavior records and interest likelihood scores in various categories, the server can provide automatic collaboration among the users, which may enable the users to efficiently collaborate with each other in information exchange and information recommendations. FIG. 12 illustrates an example of online collaboration. One exemplary category 1203, Art/Music/Rock'n'Roll/Bon Jovi/, may show on many user's interest profiles. For those who show interest in the category, there must be some activities related to Bon Jovi. Table 1201 is an exemplary interest likelihood profile for a registered user (ID: 290371), which contains Bon Jovi in his interest category 1211, with 5% as its likelihood score 1212. The server may also summarize all the collected online behavior records related to Bon Jovi for the registered user, and summarize them into different summary lists 1213, inside the summary 1203 for the particular category. Inside each list 1213, there may be many associated online behavior records, ranked with scores. Furthermore, there may be one summary of summaries, which summarizes all the information inside each user's Bon Jovi related summary. These summaries, one for each category, may become the basis for collaboration among users' actions in each category. For example, it can be used for making recommendations to any user, by way of comparing the difference between the general summary per category and the specific user's summary per category, summarizing the difference, and making recommendations to the user based upon the summarized differences.

Online collaboration, particularly the collaborative filtering is well known and getting particularly popular in today's eCommerce activities. Amazon's recommendation module is one example which is used to recommend books/videos/DVDs to the user, based on the user's current and historical transaction record. However, Amazon does not apply the collaboration across sites or categories and is limited by their data collection capability.

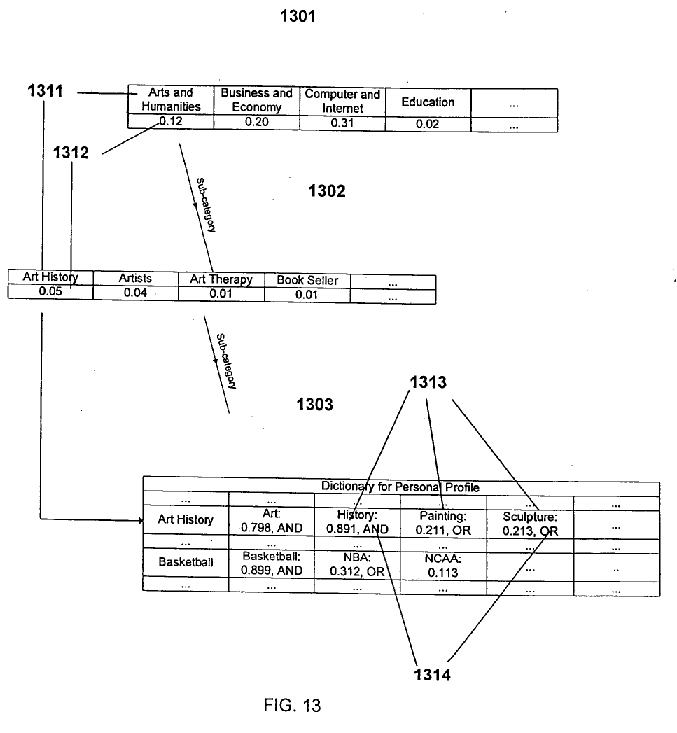

Application modules including a searching assistant module may help the user to search contextual objects within the range of the user's previously selected records, via presenting the intersection of the search result from the index table and the URL shown in the user's online behavior record. The application module may also help the user to search contextual objects within the category of the specific interest categories derived from the previously selected records. When the user's interest profile is built, there are a variety of approaches to achieve the personalized searching. FIG. 13 illustrates an example of using query expanding to do the personalized search. Table 1301 and 1302 are collections of one user's interest likelihood scores 1312 over the hierarchical categories 1311. A category dictionary table 1303 presents the distinguished words 1313 and associated logical operators 1314, forming the contextual environment for the articles belonging to the category. The users' interest category profile, associated with the words and operators, can be used to guide the users to search through their interest category, and get better-ranked search results by converting the simple query to an expanded query with these distinguished words 1313 and operators 1314.

A browsing assistant module may guide the user in browsing through the user's previously selected online objects (e.g., web pages) and recommend to the user follow-up changes and new objects whose contents are relevant to the previously selected online objects, or objects whose contents fall into the interesting category of the user. Compared to personal services provided to registered users by online giants like Yahoo, AOL, MSN, and even Amazon, the system of the invention can cover a much wider range of user's online activity, analyze the user's interests in greater detail, and reflect the user's most recent interests more dynamically.

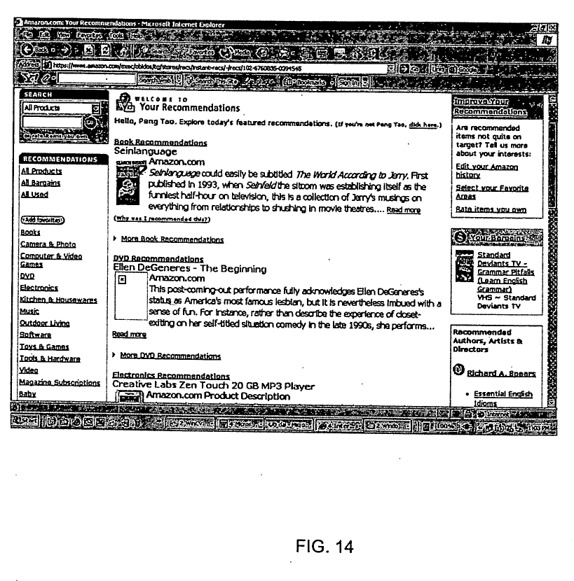

An ecommerce assistant module may help the user track and manage all the previously-selected eCommerce activities, such as browsing or purchasing something online, and transaction records. The ecommerce assistant module may also recommend to the user some interesting special offerings based on the user's previous eCommerce activity records. One example is illustrated in the Collaboration Module. FIG. 14 shows a recommendation page for a registered Amazon user, which is limited to the selling of Amazon items.

An integration assistant module may help the user integrate any applications, including self-developed components, as an actionable UI component into the personal information system. For example, the user can embed functional features such as lookup of a ‘marked’ word in a dictionary, or an English-Chinese translation of the marked phrases and their pronunciation.

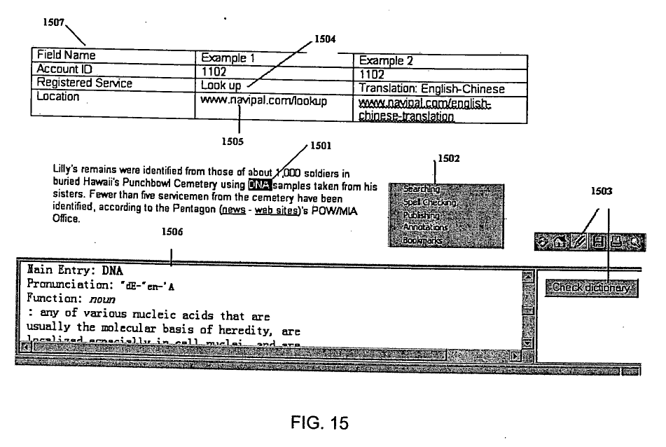

The personal online information management system provides a platform for users, developers, or any third party vendors to define, develop, and share applications associated with the contextual web contents. All these applications may be published in the repository of applications in a public URL of the system, and the user can easily choose and integrate the applications they want into their personal annotation system. The applications can be web services or downloadable .dll or .exe. FIG. 15 also shows an exemplary integration user scenario. The table 1507 is used to store information related to the user chosen applications, such as the name and location of the service, in the user's personal annotation management system. When the user logs on the user's personal annotation system, a personalized UI, with the selected buttons 1503, or menu items of a pull-down menu 1502, which represent the user chosen applications, will be retrieved from the table and shown on the browser. In FIG. 15, a highlight of the marked content 1501 and a click on the ‘Look up’ button, or a corresponding menu item, will always send a request associated with the marked content to the application link to the location 1505 of the service 1504, which can be a local .exe or .dll, or a web service in nature. The application will then process the request, and return the result 1506.

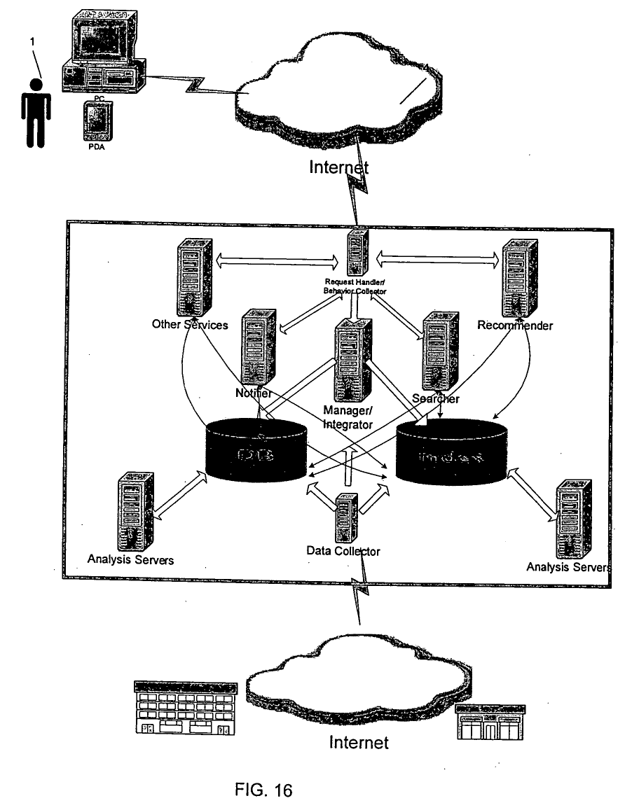

FIG. 16 illustrates the layout of the application functional modules in the server side.

There is an alternative approach that enables the users to collect, manage, and use their online behaviors during their online activities in real time, without releasing the collected information to the service provider. In this approach, the user can send the collected information to the service provider or save the collected information to a local repository. One disadvantage of the latter approach is that the saved content cannot be analyzed, managed and retrieved efficiently, as the powerful analytical and search engines are usually on server side, including using a big knowledge base and index table. One simple example is the PC searching functionality “search for files and folders” referred to above. This functionality is usually inefficient and slow compared to server side searching. The other disadvantage is that all the information stays in the local client side and and no recommendations can be made.

For the privacy sensitive user, the user may be provided with a specific-purpose email account, associated with the user's account and/or virtual registered ID of the service provider. This email account will be only used for the communication between the user and the personal online information management service provider, which is registered online when the user subscribes to the personal online information management service, or installed in the user's local machine when the user installs the client of personal online information locally. In either case, the specific email account will be bundled with the service, and will only be used for communications between the user and the service provider, and will be automatically terminated when the user terminates the service.

Technically, there should be no third party spam associated with the email, as it is only known by and used by the user and the service provider. No user's real life identity, including email address and contact information need to be released, so this approach will be absolutely spam free, far beyond the P3P in terms of privacy protection.

The personal online information management system of the invention provides a system that enables the user to select content and web resources and to record the selected content and web resources for future retrieval. The system further enables the user to record the user's actions associated with such content and web resources. The system enables the user to easily and precisely control the monitoring and recording of the content and the user's actions associated with the content and make them useful in the future. The system further provides users with absolute control over which activities and online resources are recorded and ensures the privacy of the user.

1-20. (canceled)

21. A personal information management system comprising:
an information collection module having a client side switch module, the information collection module being coupled to a server side behavior collector module and being operable to enable a user to selectively save, manage and retrieve content accessed in a network environment, the client side switch module allowing user control of said saving, managing and retrieving.

22. The personal information management system of claim 21, further comprising a server side information analysis and management module coupled to the server side behavior collector module.

23. The personal information management system of claim 22, further comprising a server side application module coupled to the server side behavior collector module.

24. The personal information management system of claim 21, wherein the client side switch module comprises a user interface component and a client side process operable to switch between a monitored mode and an un-monitored mode responsive to user input.

25. The personal information management system of claim 24, wherein the user interface component comprises a button displayed on a toolbar.

26. The personal information management system of claim 24, wherein the monitored mode comprises sending content of web resources visited by the user to the server side behavior collector module.

27. The personal information management system of claim 26, wherein the content of the web resources comprises a URL of the visited web resource.

28. The personal information management system of claim 26, wherein the content of the web resources comprises a returned search result.

29. The personal information management system of claim 24, wherein the monitored mode comprises sending the user's actions on web resources visited by the user to the server side behavior collector module.

30. The personal information management system of claim 29, wherein the user's actions comprise browsing content of a text object.

31. A personal information management system comprising:
an information collection module having a client side switch module, the information collection module being coupled to a server side behavior collector module, the client side switch module operable to provide user control of saving, managing and retrieving of information accessed in a network environment;
a server side information analysis and management module coupled to the server side behavior collector module; and
a server side application module coupled to the server side behavior collector module.

32. The personal information management system of claim 31, wherein the server side information analysis and management module comprises a content analysis server, a category repository and an index table.

33. The personal information management system of claim 31, further comprising a server side user behavior analysis module coupled to the server side information analysis and management module.

34. The personal information management system of claim 33, wherein the server side user behavior analysis module comprises a user behavior analysis server and a user behavior repository.

35. The personal information management system of claim 31, further comprising a server side collaboration module coupled to the server side information analysis and management module.

36. The personal information management system of claim 35, wherein the server side collaboration module comprises a collaboration server and a collaborative summary repository.

37. A personal information management system for monitoring, storing, managing and providing to a user the user's online behaviors comprising:
an information collection module having a client side switch module, the information collection module being coupled to a server side behavior collector module, the client side switch being operable to allow the user to switch between a monitored mode and an un-monitored mode;
a server side information analysis and management module coupled to the information collection module, the server side information analysis and management module comprising a content analysis server, a category repository and an index table;
a server side application module coupled to the server side behavior collector module, the server side application module comprising a search module;
a server side user behavior analysis module coupled to the server side behavior collector module; and
a server side collaboration module coupled to the server side behavior collector module.

38. The personal information management system of claim 37, wherein the monitored mode comprises sending content of web resources visited by the user to the server side behavior collector module.

39. The personal information management system of claim 37, wherein the monitored mode comprises sending content of web resources visited by the user to the server side behavior collector module.

40. The personal information management system of claim 37, the monitored mode comprises sending the user's actions on web resources visited by the user to the server side behavior collector module.
